(19) United States
(12) Patent Application Publication
(10) Pub. No.: US 2022/0169110 A1
(43) Pub. Date: Jun. 2, 2022

(54) High Flow Non Pressurised Filling Control Valve

(71) Applicant: Weir Minerals Australia Ltd, Artarmon, NS W (AU)

(72) Inventors: Aidan Bryant, Kuluin (AU); Luke Laurikainen, Buderim (AU); John James Fulford, Bli Bli (AU); Jeremy Hanhiniemi, Narangba (AU)

(21) Appl. No.: 17/441,393

(22) PCT Filed: Mar. 17, 2020
(86) PCT No.: PCT/AU2020/050253

§ 371 Date: Sep. 21, 2021

(30) Foreign Application Priority Data
Mar. 21, 2019 (AU) 2019900961

(51) Int. Cl. B60K 15/035; F16K 17/04; F16K 24/04; F16K 24/06; F16K 1/20; F16K 15/02; F16K 3/24; F16K 31/30

(52) U.S. Cl. CPC B60K 15/03519; F16K 17/0413; F16K 24/044; F16K 24/06; B60K 2015/03256; F16K 15/02; F16K 3/246; F16K 31/30; F16K 1/205

(57) ABSTRACT

A valve assembly for use with a container such as a fuel tank. Embodiments of the assembly include an inlet and outlet provided on separate sides of the central axis of a housing, the housing being connected to a central conduit located in a container. The valve assembly includes inlet and outlet valves which allow the venting of air during filling and the intake of air as fuel is consumed. The valve assembly is arranged so that air flows through a less torturous path compared to known prior art, enabling a high rate of filling to be achieved.

### TECHNICAL FIELD

The present disclosure relates to a valve assembly for use with a container such as a fuel tank.

### BACKGROUND OF THE DISCLOSURE

Typical fuel and liquid re-fuelling technology fills and refills diesel tanks at a comparatively slow rate. In many industries, for example: mines, quarries, construction sites, and rail or marine applications, the downtime associated with re-fuelling is costly. Accordingly, if the time required for refuelling can be reduced, substantial cost and time savings can be achieved.

The time required for refuelling is limited by the ability of the tank to vent the air contained within it as it is filled. When the flow rate exceeds the capacity of the tank to vent air, the fuel tank will pressurise. This is undesirable as it can lead to damage, rupture of the fuel tank and/or environmental release of the contents of the tank. Pressurisation may also occur if the tank includes a float valve to prevent spillage. If the tank is overfilled, this valve will act to seal and pressurise the tank. Shut off mechanisms are thus required to close the filling nozzle when a tank is filled to a predetermined level below that which would cause pressurisation.

Breather valves, which allow the tank to vent air during filling and/or serve part of a level control system, are known in the art. One example is known in US2016288640, which discloses a valve assembly featuring a level control system and breather valve for attachment to a fuel tank. As the tank fills, air is allowed to leave the tank through the breather valve. Similarly, as fuel is consumed, the breather valve allows the flow of air into the tank. In both cases, the breather valve serves to prevent the tank pressurising. Otherwise stated, these valves act to regulate pressure between an exterior and an interior of a container such as a fuel tank. The assembly further includes a relief valve in the form of a spring and relief plate that rises under pressure to reveal relief holes, allowing the contents of the tank to be expelled if overfilled or in the event that the breather valve malfunctions. As protection against fuel being expelled if the tank is overturned, a rollover protection valve is also supplied in line with the central axis of the assembly which will close if the tank is rotated past a threshold angle, preventing fuel from being released from the tank.

This assembly however is unable to sufficiently vent the tank for higher filling rates, desirably between 1500 and 2000 L/min or greater. This is partially due to the flow path which air takes when leaving the tank, in which it must pass around the rollover and relief valves. Further, the assembly is unsuited for applications where there is only a small amount of clearance around the tank.

Accordingly, the present invention seeks to at least partially overcome these issues, providing a valve assembly which allows higher filling rates and providing a reduced profile above the tank.

### SUMMARY

In a first aspect, there is provided a valve assembly for use with a container, the assembly comprising; at least one conduit in fluid communication with the interior of the container, at least one outlet in fluid communication with the exterior of the container, at least one inlet in fluid communication with the exterior of the container, wherein the inlet allows one way fluid communication from the exterior of the container to the at least one conduit, a housing containing a channel allowing fluid communication between the at least one conduit and the at least one outlet; and an outlet valve located within the channel adapted to allow movement between an open and a closed position; an open position which allows one way fluid communication from the at least one conduit to the at least one outlet; and a closed position which prevents fluid communication from the at least one conduit to the at least one outlet, wherein the outlet valve moves to the open position when the pressure of the interior of the container is greater than the pressure of the exterior of the container and moves to the closed position when the pressure of the interior of the container is less than the pressure of the exterior of the container; wherein when the outlet valve is in the open position, a substantially unobstructed flow path is defined from the interior of the container through the conduit, channel, outlet valve and outlet to the exterior of the container, wherein the housing includes a central axis and comprises an outlet side containing the at least one outlet and the outlet valve, and an inlet side containing the at least one inlet, the outlet side and the inlet side being adjacent in the housing on a plane substantially transverse to the central axis.

In certain embodiments, the outlet way valve is hinged to allow movement between the open and closed positions.

In certain embodiments, the outlet valve is hinged at a location proximate a central axis of the housing.

In certain embodiments, the outlet valve is positioned substantially horizontally when in a closed position.

In certain embodiments, the assembly further comprises a rollover protection device located within the housing which prevents fluid communication through the channel if the container is rotated past a threshold angle which would otherwise cause fluid to flow through the channel due to gravity.

In certain embodiments, the rollover protection device is located substantially outside of the flow path when the container is not rotated past the threshold angle.

In certain embodiments, the rollover protection device is offset from the central axis.

In certain embodiments, the rollover protection device comprises a float disposed on a shaft so that it is movable along a long axis of the shaft.

In certain embodiments, the shaft is a cantilevered shaft.

In certain embodiments, the rollover protection device further comprises a weight disposed on the shaft, wherein the weight is movable along a long axis of the shaft and wherein the weight is not connected to the float.

In certain embodiments, the weight is disposed on the shaft on top of the float.

In certain embodiments, the weight is disposed on the shaft below the float.

In certain embodiments, the weight is disposed on the shaft in a cavity of the float.

In certain embodiments, the rollover protection device further comprises a weight movable along a long axis of the shaft and the weight is connected to the float.

In certain embodiments, a spring is located at the base of the shaft, underneath the float.

In certain embodiments, the rollover protection device comprises an air shield adapted to prevent premature engagement of the float from air escaping during air pressure relief from the interior of the container to the outlet valve.

In certain embodiments, the air shield redirects the air above or around the float.

In certain embodiments, the housing is substantially cylindrical.

In certain embodiments, the assembly further comprises a machined insert located on the housing suitable for attaching a high pressure relief valve or similar device which allows fluid communication with the exterior of the container when the pressure of the interior of the container exceeds a set threshold value.

In certain embodiments, the high pressure relief valve or similar device is provided in the form of a bursting disc.

In certain embodiments, the assembly further comprises a filter located within the housing between the at least one inlet and the at least one conduit such that any fluid that passes from the at least one inlet is filtered prior to entering the at least one conduit.

In certain embodiments, the assembly further comprises; a pilot line located within and which extends substantially along the length of the conduit; and a float valve located within the conduit offset from a main axis of the conduit, wherein; the float valve moves from a first position where fluid communication is possible through the pilot line to a second position where fluid is prevented passing through the pilot line, the float moving to the second position when the container is filled to a set level.

In certain embodiments, the central conduit includes a first set of openings located towards an end distal to the housing and a second set of openings located proximal to the housing wherein the second set of openings is sized to have a greater area than the first set.

In certain embodiments, the assembly further comprises an attachment point in the housing for an elbow or similar conduit such that fluid can enter into the channel of the housing from a location remote to the assembly.

In certain embodiments, a filter is located within a conduit remote to the assembly, said conduit being attached at the attachment point to the housing.

In certain embodiments, the conduit is attached to the container by means of a seal.

In certain embodiments, the seal is retained by at least one clip such that orientation of the conduit and housing relative to the container can be changed.

In certain embodiments, the assembly further comprises a visual failure indicator including a pressure-activated valve and a chamber containing a visual indicator, wherein the valve only permits liquid to enter the chamber when a predetermined pressure is reached; and the visual indicator allows a user to determine when liquid has entered the chamber.

In certain embodiments, the container is a fuel tank.

In certain embodiments, the conduit is sized to fit a standard 2″ NPT thread.

According to a second aspect, there is provided a container containing a valve assembly according to the first aspect.

In certain embodiments of the second aspect, the container is a fuel tank.

### DESCRIPTION OF THE FIGURES

FIG. 1 shows a cross-sectional view of one embodiment of the invention.

FIG. 2 shows a cross-sectional view of another angle of the embodiment shown in FIG. 1.

FIG. 3 shows another cross-sectional view of the embodiment shown in FIGS. 1 and 2

FIG. 4 shows the flow paths of air and fuel through the assembly during different phases of operation.

FIG. 5A shows a further embodiment including a weight and air shield in the rollover protection device. FIGS. 5B and 5C show alternative embodiments of the rollover protection device.

FIG. 6 shows a further embodiment wherein the air filtering element is not located within the housing.

FIG. 7 shows a further embodiment including a visual indicator of pilot line failure.

### DETAILED DESCRIPTION

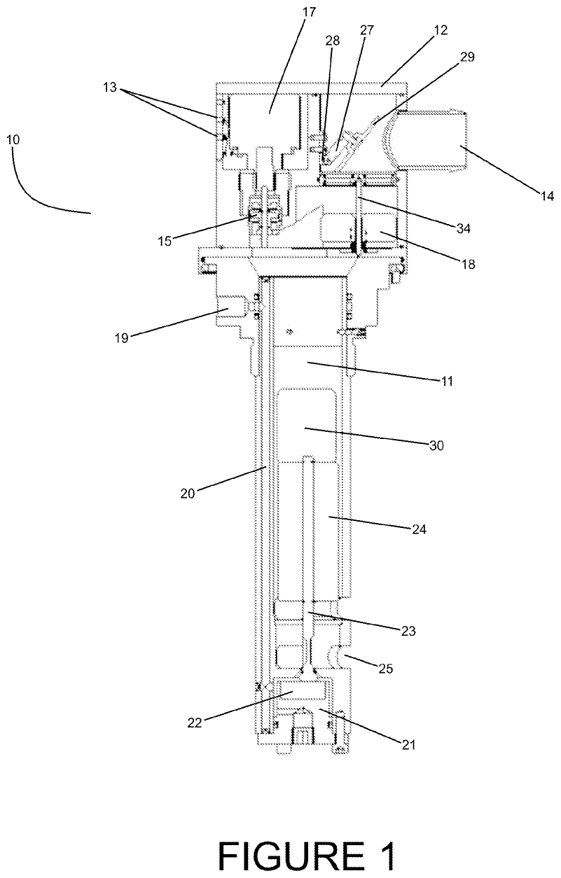

FIG. 1 shows an embodiment of an assembly 10 for use with a fuel tank. The assembly 10 includes a main body consisting of inlets 13 and outlet 14 within a housing 12, and a central conduit 11 that extends into the fuel tank from the housing 12. The main body is located external to the fuel tank while the central conduit 11 is located on an interior of the fuel tank. The central conduit further contains a pilot line conduit 20 and float valve 24 to prevent overfilling. The central conduit features two sets of apertures 25 and 30. The first set of apertures 25 is located at a distal end of the central conduit, away from the main body, while the second set of apertures 30 are located at a proximal end. The second set of apertures 30 are sized to be larger in area than the first set 25. The first set of apertures 25 is primarily used to allow fuel to enter the tank and to allow fuel to surround and lift the float valve 24 as the fuel level rises. The second set of apertures 30 is primarily used to allow air to pass between the central conduit 11 and the tank. In preferred embodiments, the housing 12 has a substantially cylindrical shape, although in other embodiments, the housing 12 may have a different shape.

When fuel is consumed, air must be allowed to enter the tank in order to prevent pressurization of the fuel tank. Air is able to enter the fuel tank through inlets 13, filter through air filtering element 17 then pass through inlet check valve 15 into the container by the central conduit 11. Inlet check valve 15 only permits fluid flow in one direction from inlet 13 to the central conduit 11 and only opens when the pressure inside the fuel tank is less than the pressure outside the fuel tank. By contrast, when the fuel tank is being refilled, air must leave the tank to avoid pressurization. Air is allowed to exit the tank through central conduit 11, outlet valve 16 and through outlet 14. Outlet valve 16 only permits fluid flow out of the tank and only opens when the pressure within the tank is greater than the pressure outside of the tank. The housing can be considered to be divided into two halves; a first half (an inlet side) for incoming air consisting of inlets 13 located in an upper side surface of the housing, air filtering element 17 and inlet check valve 15, and a second half (an outlet side) for outgoing air consisting of outlet 14 located in an upper side surface of the housing and outlet valve 16. The rollover protection device 18 is also located in the second half as it is used to allow or prevent fluid from leaving the apparatus. The rollover protection device 18 is located in a lower portion of the housing offset from the central axis such that it lies in the second half and is located substantially out of the flow path of outgoing air when in its normal condition. The first half and the second half may be positioned adjacent and transverse to the central axis of the housing, as shown in the FIGs.

The outlet valve 16 is configured so that it lies substantially horizontally when in a closed position, that is to say substantially normal to the central axis of the assembly. This is advantageous as in many practical situations, the fuel tank (and accordingly, the assembly) will operate at a range of angles deviating from the horizontal. For example, a fuel tank mounted in a truck will change angles as the truck travels down a haul road decline. The horizontal mounting of the valve prevents it from being opened due to gravity when the tank is operating at angles off the horizontal, stopping unfiltered air from entering from the outlet 14. As shown in FIG. 1, this outlet valve 16 may be in the form of a plate or flap 29 and a hinge 28 which allows the plate or flap to move from a closed position where it is substantially normal to the central axis of the assembly and where fluid is unable to pass into the outlet to an open position where it forms an acute angle with the central axis of the assembly and in which fluid is able to pass into the outlet. In this embodiment, the hinge is located at least partially on the central axis. It will be understood that in other embodiments, the hinge may be offset from the central axis or in a region proximate to the central axis. Further, the outlet valve includes an arm 27 which connects the hinge 28 and flap 29 together. This arrangement allows the flap to form a seal when in the closed position without requiring considerations for sealing the hinge.

The assembly shown in FIG. 1 also includes a rollover protection device 18 located within the housing 12. The purpose of the rollover protection device 18 is to seal the outlet in the event of the tank being overturned, as well as in the event that the fluid level rises into the assembly, for example if the pilot line fails and the tank is overfilled. The rollover protection device is located eccentrically within the housing, that is to say offset from the central axis of the assembly, so that outgoing air is not obstructed by the rollover device outside of rollover conditions. This valve moves from a normal condition where fluid can pass around one side of the device and through outlet valve 16 to a second position where fluid flow is prevented from passing to outlet valve 16 and moves from the first to second position either when the assembly is rotated more than an angle which would cause fuel to enter the breather valve or when the fluid level rises into the assembly. This prevents fuel from leaving the fuel tank through the outlet 16 in the event of for example, the fuel tank overturning or the tank overfilling. This prevents undesirable environmental release of fuel which may also create a dangerous situation for people in the vicinity of the overturned fuel tank.

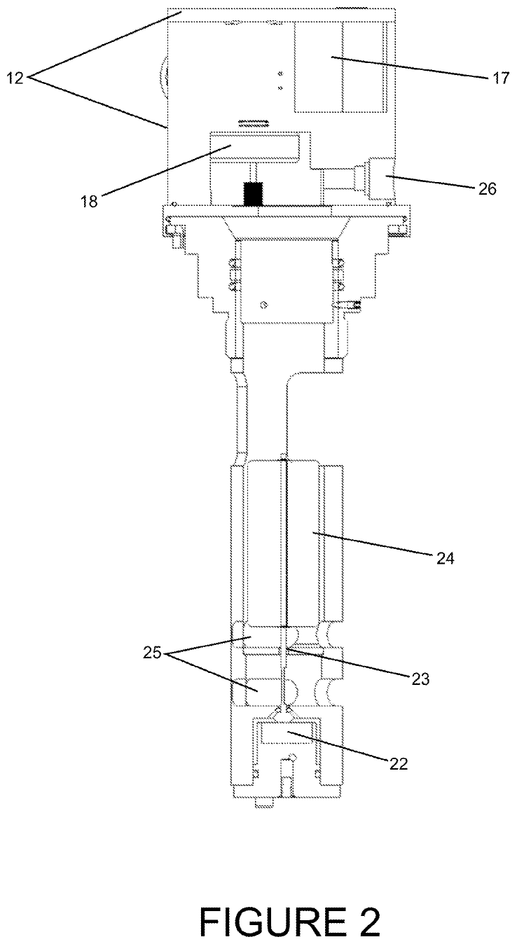

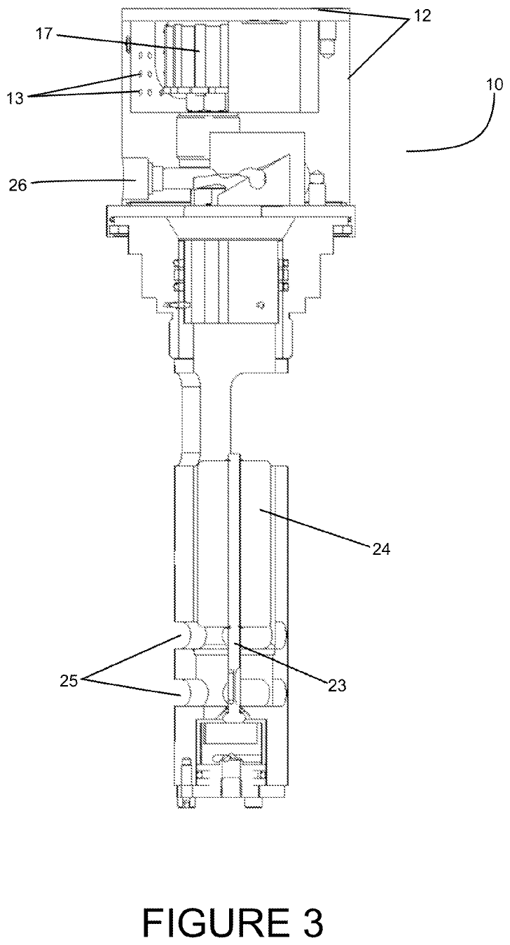

The rollover protection device 18 comprises a float attached to a shaft such that it can move along the shaft's long axis. The float may be shaped substantially cylindrically as in FIG. 1, or any other shape which can be attached to the shaft 34 so as to allow movement along the long axis of the shaft 34. In this embodiment, a weight is disposed on the shaft 34 underneath the float. This weight is free to move along the shaft and unconnected to the float so that in the circumstance that fluid enters the assembly, the float is able to rise to seal the outlet while the weight will remain at the base of the shaft. In the circumstance that the assembly is rotated more than a threshold value, the weight will move along the long axis of the shaft under the force of gravity to ensure the float to a closed position. In FIGS. 2-3, the float is shown at the top of the shaft. This only occurs when the rollover protection device 18 is in a rollover condition, which occurs when the container is overturned. It will be seen that when the float is in this position, the float blocks the channel proximate the outlet valve 16. In the normal condition, when the container is not overturned, the float is located towards the bottom of the shaft as shown in FIG. 1 so that an unobstructed flow path for air exiting the container is created through the assembly.

During refilling, fuel enters the tank through a filling valve (not shown). A portion of the fuel being added is in communication with the pilot line port 19 so that fuel travels through the pilot line conduit 20 and enters the tank through the liquid chamber 21 and apertures 25. Inside the liquid chamber 21 is seal 22, attached by shaft 23 to float valve 24. As the fuel level in the tank rises, float valve 24 rises from a first position where fuel can pass into the tank from the liquid chamber 21, to a second position where seal 22 prevents fuel from leaving the liquid chamber. This causes the direction of the flow of fuel through pilot line conduit to reverse, providing a pressure which causes the filling valve to close, preventing overfilling and pressurisation of the tank. During this time, air is able to pass through a second, larger set of apertures 30 which are located such that they are located above the maximum fuel level of the tank so that air is always able to pass through them into the central conduit 11. The second set of apertures 30 are larger than the first set 25 to allow maximal airflow into the assembly and hence enable faster filling rates of the tank.

The embodiment shown in FIGS. 2 and 3 also show machining insert 26. In the event of a malfunction, for example failure of the outlet valve or continued filling after the float valve moves to the second position, the tank may pressurise, possibly resulting in rupture of the tank and/or environmental release. To avoid this, a machining insert is provided in a radial direction from the central axis in which a relief valve or similar, such as a bursting disc can be provided external to the main body of the valve which will open in the event of pressurization. In other embodiments, flow through the machining insert may be used as an early controlled warning of valve failure.

The machining insert 26 allows the relief valve or similar to be distal from the main body. This is advantageous in that the spilled fuel may be channelled to a safer location. For example, the main body of the valve may be situated near hot objects such as turbos, which pose a fire risk if fuel is expelled in their vicinity.

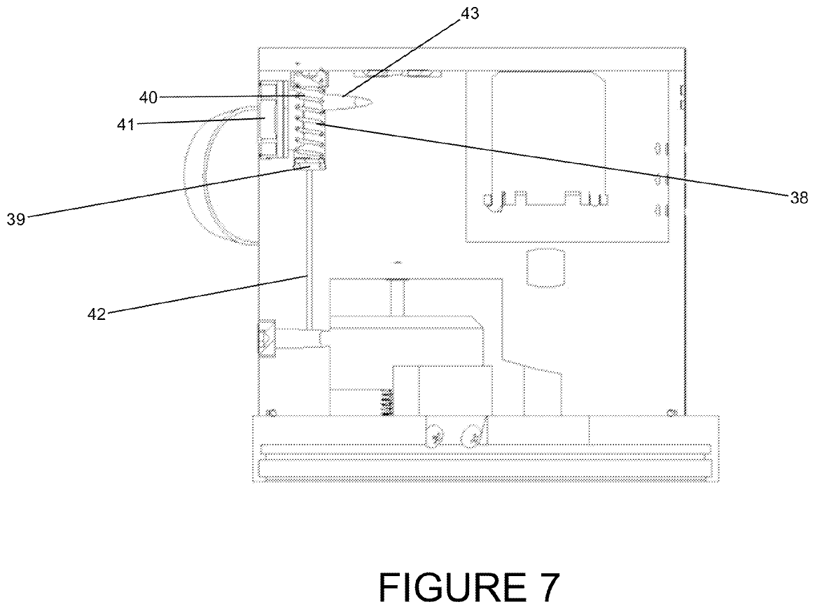

In other embodiments, the operator may prefer the tank to pressurise rather than risk release of the contents of the tank to the environment. To satisfy the operator's preference, the machining insert 26 may not be present or may be sealed so that in the event of malfunction, the tank pressurizes rather than expelling the contents of the tank. In some of these embodiments, a visual indicator may be located within the assembly to indicate that the tank is pressurizing, as shown in FIG. 7.

The assembly is designed to fit onto existing fuel tanks and similar. Accordingly, the base of the main body may be sized to fit a standard 2″ NPT connection.

The assembly allows air to be vented from the tank through a less torturous path than in prior art such as US2016288640 where air must pass around a relief valve. The flow path is further improved by the location of the rollover protection valve eccentrically in the housing, allowing a gentle S-bend path for the air to take as opposed to the more complex path when locating the valve centrally. Further, air is able to pass through the assembly without encountering any substantial obstructions or requiring the air to split into multiple flow paths. This flow path allows the present invention to achieve flow rates of up to 2000 L/min or higher, surpassing the current filling flow rates achievable by the prior art.

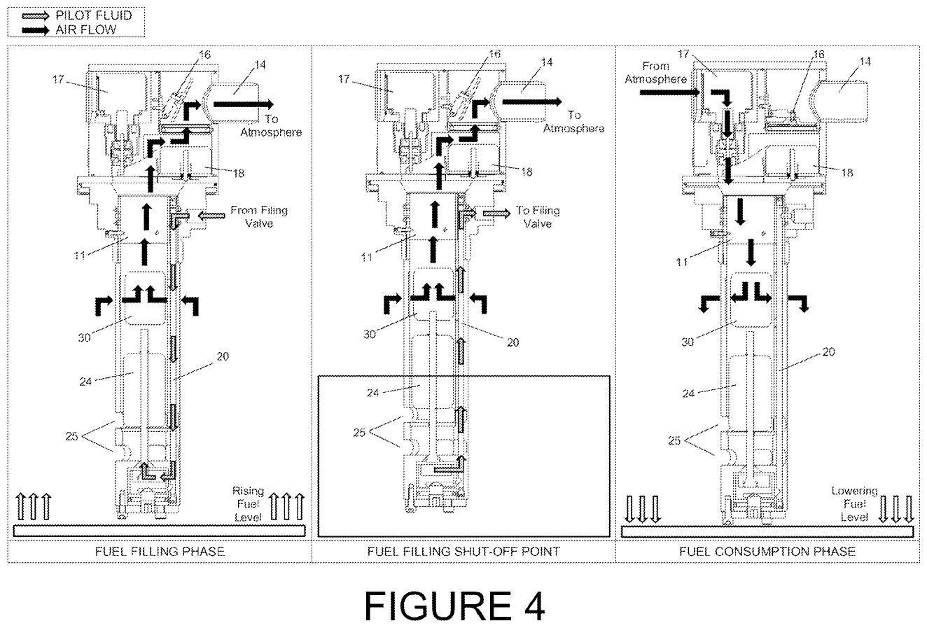

A diagram illustrating the flow path during filling the tank and during fuel consumption is shown in FIG. 4. In the fuel filling phase, the flow path of air (shown as red arrows) leaving the tank through the assembly. Air enters the central conduit 11 from the interior of the tank through the larger set of apertures 30 and passes from the central conduit 11 into the main body of the assembly. In this diagram, the rollover device 18 is seen in its initial position, that is to say that the float is located towards the lower end of the shaft. As the shaft is offset from the central axis of the main body and the central conduit 11 and the float is located at its lower end, a flow path is defined in which the air is able to pass through to the outlet without splitting or encountering any significant obstruction. In the diagram of this phase, the outlet valve 16 can be seen in an open position, that is to say that the flap is drawn towards the central axis of the assembly to allow air to again pass unobstructed through to the outlet. Otherwise stated, the arrangement of the rollover protection device 18 and outlet valve 16 in the open position create a gentle s-bend flow path for air leaving the container through the assembly, in contrast to the torturous flow paths of existing designs.

Also during the fuel filling phase, fuel enters the assembly from a filling valve and travels through the pilot line 20 to enter the container through the smaller set of apertures 25 located towards the distal end of the central conduit.

As the fuel level rises to a predetermined level, the float valve 24 rises as well. The float valve 24 is attached to a shaft and seal which prevents fuel from entering the central conduit 11 and the smaller set of apertures 25. This causes the fuel in the pilot line 20 to reverse direction and provide a pressure on the filling valve, preventing further filling of the tank. It can be seen that the larger set of apertures 30 are located above this predetermined level to allow air to continue to enter the central conduit through the same flow path as during filling.

During the fuel consumption phase, air must be added to the container to prevent the container from pressurising from internal vacuum. As shown in the diagram, a second flow path is utilized during this time as the outlet valve 16 is in the closed position and the flap is substantially horizontal, blocking airflow through this pathway. Air is able to enter the container through the inlet into an air filtering element. From there, the air is able to pass through a check valve into the central conduit of the assembly and into the container through the larger set of apertures.

Otherwise stated, FIG. 4 shows that two flow paths exist through the assembly. Each flow path travels through one half of the assembly, with both flow paths passing through the central conduit and the larger set of apertures. The first of these flow paths is for incoming air, and passes through the air filtering element and inlet check valve and the second is for outgoing air, which passes around the rollover device and through outlet valve to the outlet.

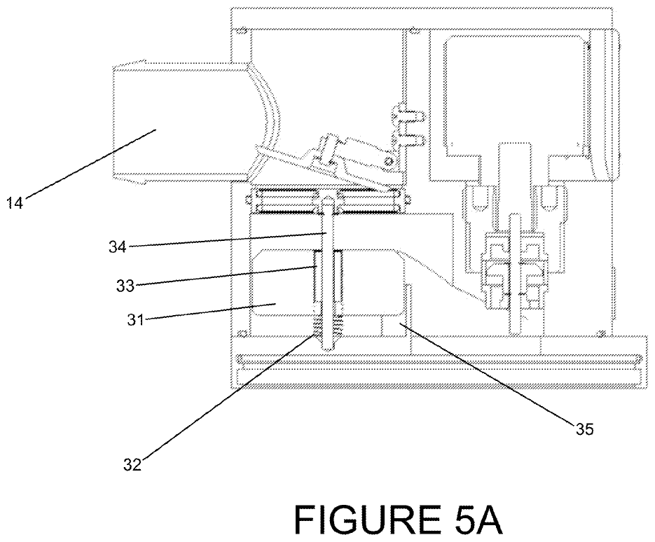

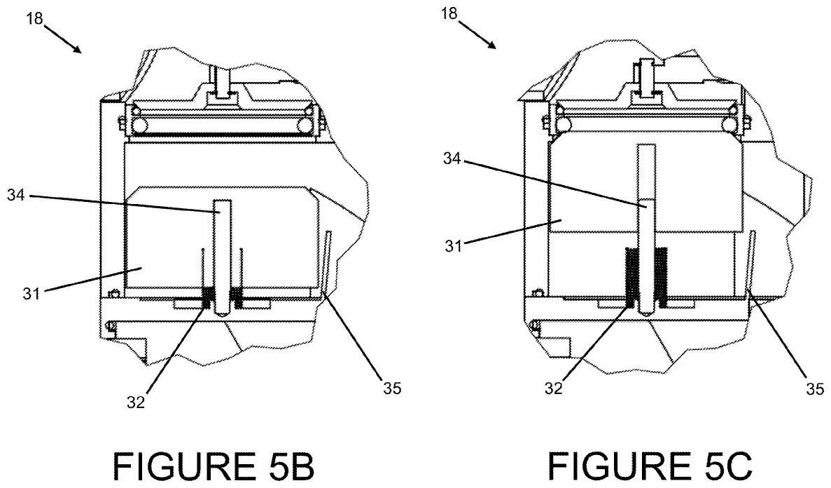

FIG. 5A shows another embodiment of the main body of the assembly. In this figure, the rollover protection device 18 is in the form of float 31, weight 33 and shaft 34. The rollover protection device 18 is shown in the normal condition, that is to say that the float 31 is located towards the bottom of shaft 33. The float 31 is located on top of a spring 32 which is located at the base of the shaft. The spring provides a tension to improve the responsiveness of the float to seal the outlet passage in the event of a rollover. The float 31 contains a recess in an upper surface in which the weight 33 sits. This weight may be glued or otherwise attached to the float, or may sit in place due to gravity. The location of the weight 33 on top of the float 31 acts as a mass dampener and prevents the float from oscillating on the shaft when air is exiting the container, allowing faster filling rates than otherwise would be possible. A further benefit of such an arrangement is that a higher spring tension is possible under the float. This prevents the float from rising due to the action of air flow as air passes the float during filling, allowing faster fill rates through the assembly, while also maintaining the responsiveness of the float to rotation during roll-over protection through the use of a higher spring tension. In other embodiments such as shown in FIG. 1, a weight is provided beneath and unattached to the float on the shaft. This provides additional sealing pressure of the rollover float when the tank is rotated without the need to increase the spring tension. This may be advantageous as a higher spring tension can increase air-flow induced oscillations and premature shutoff of filling. In further embodiments, the weight may be provided in a cavity in the float with similar advantages as above.

In alternative embodiments, the shaft 34 may instead be a cantilevered shaft with a dimensioned length. This may provide a number of functions such as to: (i) facilitate the float 31 sealing the outlet passage in a rollover position, (ii) guide the float 31 toward a normal position when the assembly is moved from the rollover position to the normal condition, and (iii) not penetrate the top surface of the float and hence provide a continuous top surface of the float. Example embodiments are illustrated in FIG. 5B, showing the float 31 in the normal condition, and FIG. 5C, showing the float 31 in the rollover position. In such embodiments, the cantilevered shaft is attached at a base of the rollover protection device 18 chamber, and the float 31 may be shaped to form a sealed cover over the end of the cantilevered shaft, providing a single sealing face about the circumference of the float 31. Moreover, while FIGS. 5B-5C do not illustrate a weight 33 as in FIG. 5A, in alternative embodiments a weight may be provided below the float 31 or in a cavity of the float 31. In further embodiments, the weight may be connected to the float 31.

Additionally, the embodiments of FIGS. 5A-5C feature an air shield structure 35 located partially around the float when in the normal condition to further ensure that a single unobstructed flow path between the central conduit and the outlet is created and that air is not inadvertently channelled underneath the rollover float where it may cause the float to oscillate—i.e. the air shield structure 35 prevents the rollover float prematurely lifting under air pressure by redirecting the air flow over and around the rollover float. This minimises the effects of low pressure eddies, the Venturi effect and other negative effects of the force if the air flow is channeled underneath the rollover float. This air shield structure 35 does not move with the float, rather it is mounted on a lower surface of the housing 12. Together, the weight 33 and air shield structure 35 reduce or prevent oscillation of the float and allow faster fuelling rates over existing designs by reducing detrimental air flow effects during filling of the fuel tank. The presence of the air shield structure lowers the air-flow induced oscillations (and associated premature shutoff) and allows the higher spring tension associated with the embodiments wherein the weight is located above the float.

Advantageously, as the housing does not have to fit a relief valve, the height of the main body can be reduced relative to existing valve assemblies. This allows the present invention to be used in applications where there is insufficient clearance above a tank to install valve assemblies of the prior art.

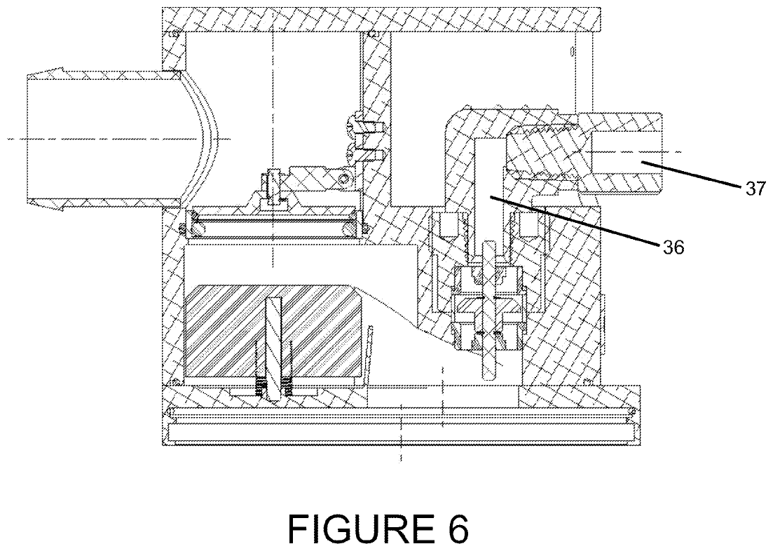

In other embodiments, it may be advantageous to receive air into the assembly from an area remote to the main body. The housing may be provided with a means of attaching an elbow or conduit in fluid communication with the inside of the tank, such as a gate or socket. This elbow or conduit may further be in fluid communication with an air filtering element and intake remote from the main body of the assembly, and may take the place of the air filtering element and intake in the housing. An embodiment with this consideration is shown in FIG. 6, where a conduit 36 with a 90° elbow is provided in place of the air filtering element shown in FIGS. 1 to 5A. This conduit 36 further includes a screw thread 37 for coupling to an external conduit (not shown) in which a filter can be located. This allows the inlet and filtering to receive air from a location remote to the main body, which in some circumstances may include less pollutants. It also allows a reduced profile of the main body.

FIG. 7 shows a further embodiment where a pilot line failure indicator 38 is provided in the main body. The pilot line failure indicator includes a failure indication valve 39, chamber 40 and visual indicator 41. The failure indicator is connected to the interior of the housing via failure conduits 42 and 43. In the event that the pilot line fails to shut off fuel during the filling phase, fuel will enter the main body of the housing. A portion of the fuel will be channelled through conduit 42 into the failure indicator 38 to provide a visual indication of the failure. In the event that the tank is pressurising, failure valve 39 will open, allowing fuel to enter the chamber 40 where the visual indicator 41 allows a user to realise that pressurisation has occurred. The indication may be carried out by a number of methods, for example by providing a point for inserting test strips for detecting oil in water known in the art to the failure indicator 38 which provide a colour change when fuel is detected. Conduit 43 allows fuel to leave the chamber 40.

A number of elements contribute to allow faster fuelling rates compared with existing designs. The arrangement of the rollover device 18 offset from the central axis of the main body provides for a single unobstructed flow path for exiting air through the assembly, as does the configuration of the outlet valve 16 and the mass-dampening achieved with weight 33. The faster fuelling rates are also enabled by the relative sizing of the second set of apertures 30 (used for airflow) compared to the first set 25 (used for fuel). The larger sizing allows air to flow into the central conduit at a faster rate than a smaller sized aperture would allow.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

### LIST OF PARTS

10 Valve assembly
11 Central conduit
12 Housing
13 Inlets
14 Outlet
15 Inlet check valve
16 Outlet valve
17 Air filtering element
18 Rollover protection device
19 Pilot line port
20 Pilot line conduit
21 Liquid chamber
22 Seal
23 Shaft
24 Float valve
25 First set of apertures
26 Machining insert
27 Outlet valve arm
28 Outlet valve hinge
29 Outlet valve flap
30 Second set of apertures
31 Float
32 Spring
33 Weight
34 Shaft
35 Air shield structure
36 Conduit
37 Screw thread
38 Pilot line failure indicator
39 Failure valve
40 Chamber
41 Visual indicator
42 First failure indicator conduit
43 Second failure indicator conduit

1. A valve assembly for use with a container, the assembly comprising;
at least one conduit in fluid communication with the interior of the container,
at least one outlet in fluid communication with the exterior of the container,
at least one inlet in fluid communication with the exterior of the container, wherein the inlet allows one way fluid communication from the exterior of the container to the at least one conduit,
a housing containing a channel allowing fluid communication between the at least one conduit and the at least one outlet; and
an outlet valve located within the channel adapted to allow movement between an open and a closed position;
an open position which allows one way fluid communication from the at least one conduit to the at least one outlet; and
a closed position which prevents fluid communication from the at least one conduit to the at least one outlet,
wherein the outlet valve moves to the open position when the pressure of the interior of the container is greater than the pressure of the exterior of the container and moves to the closed position when the pressure of the interior of the container is less than the pressure of the exterior of the container;
wherein when the outlet valve is in the open position, a substantially unobstructed flow path is defined from the interior of the container through the conduit, channel, outlet valve and outlet to the exterior of the container,
wherein the housing includes a central axis and comprises an outlet side containing the at least one outlet and the outlet valve, and an inlet side containing the at least one inlet, the outlet side and the inlet side being adjacent in the housing on a plane substantially transverse to the central axis.

2. (canceled)

3. The assembly of claim 1, wherein the outlet valve is hinged at a location proximate a central axis of the housing to allow movement between the open and closed positions.

4. The assembly of claim 1, wherein the outlet valve is positioned substantially horizontally when in a closed position.

5. The assembly according to claim 1, further comprising a rollover protection device located within the housing which prevents fluid communication through the channel if the container is rotated past a threshold angle which would otherwise cause fluid to flow through the channel due to gravity.

6. The assembly according to claim 5, wherein the rollover protection device is located substantially outside of the flow path when the container is not rotated past the threshold angle.

7. The assembly according to claim 6, wherein the rollover protection device is offset from the central axis.

8. The assembly according to claim 5, wherein the rollover protection device comprises a float disposed on a shaft so that it is movable along a long axis of the shaft.

9. The assembly according to claim 8, wherein the shaft is a cantilevered shaft.

10. The assembly according to claim 8, wherein the rollover protection device further comprises a weight disposed on the shaft, wherein the weight is movable along a long axis of the shaft,

11. The assembly of claim 10, wherein the weight is disposed on the shaft on top of the float.

12. The assembly of claim 10, wherein the weight is disposed on the shaft below the float.

13. The assembly of claim 10, wherein the weight is disposed on the shaft in a cavity of the float.

14. (canceled)

15. The assembly according to claim 8, wherein a spring is located at the base of the shaft, underneath the float.

16. The assembly according to claim 5, wherein the rollover protection device comprises an air shield adapted to prevent premature engagement of the float from air escaping during air pressure relief from the interior of the container to the outlet valve.

17-18. (canceled)

19. The assembly according to claim 1, further comprising a machined insert located on the housing suitable for attaching a high pressure relief valve or similar device which allows fluid communication with the exterior of the container when the pressure of the interior of the container exceeds a set threshold value.

20. (canceled)

21. The assembly of claim 1, further comprising a filter located within the housing between the at least one inlet and the at least one conduit such that any fluid that passes from the at least one inlet is filtered prior to entering the at least one conduit.

22. The assembly according to claim 1, further comprising;
a pilot line located within, and which extends substantially along, the length of the conduit; and
a float valve located within the conduit offset from a main axis of the conduit, wherein;
the float valve moves from a first position where fluid communication is possible through the pilot line to a second position where fluid is prevented passing through the pilot line, the float moving to the second position when the container is filled to a set level.

23. (canceled)

24. The assembly according to claim 1, further comprising an attachment point in the housing for an elbow or similar conduit such that fluid can enter into the channel of the housing from a location remote to the assembly.

25-27. (canceled)

28. The assembly according to claim 1, further comprising a visual failure indicator including a pressure-activated valve and a chamber containing a visual indicator; wherein the valve only permits liquid to enter the chamber when a predetermined pressure is reached; and the visual indicator allows a user to determine when liquid has entered the chamber.

29-39. (canceled)

31. A container containing a valve assembly according to claim 1.

32. (canceled)
